(19) United States
(12) Patent Application Publication
(10) Pub. No.: US 2014/0035267 A1
(43) Pub. Date: Feb. 6, 2014

(54) PARKING DEVICE FOR A BICYCLE

(71) Applicant: Wayne-Ian Moore, Taichung City (TW)

(72) Inventor: Wayne-Ian Moore, Taichung City (TW)

(21) Appl. No.: 13/565,757

(22) Filed: Aug. 2, 2012

(51) Int. Cl. B60S 9/12

(52) U.S. Cl. 280/766.1

(57) ABSTRACT

A parking device for a bicycle includes an inflator and a connecting member. The inflator has a nozzle defined thereon. The connecting member has an inserting part at one end thereof and an assembling part at another end thereof. The inserting part of the connecting member inserted into the nozzle, the assembling part assembled on the bicycle. Under this arrangement, a user connects the inflator to the bicycle via the connecting member to park the bicycle stably; in contrast, when the user wants to ride the bicycle, the connecting member and the inflator are able to be assembled on the bicycle.

### BACKGROUND OF THE INVENTION

1. Field of the Invention

The present invention relates to a parking device, and more particularly to a parking device for a bicycle.

2. Description of Related Art

Recently, riding bicycle is quite common for people as a leisure activity, and how to park the bicycle becomes an important issue. Generally, a rider can use a conventional kickstand to park a bicycle. However, for the bicycles which are applied in speed racing, installing the conventional kickstand as an additional component is forbidden so as to avoid the personnel from damaging when bicycles collide with each other or collapse. In contrast, for those cross-country bicycles, especially for those which rides in the forests or downhill, in order to absorb impacts from the unsmooth roads, these bicycles have a buffer structure so that to install an additional conventional kickstand on the bicycles is not easy; moreover, when the rider rides the bicycle in the tree-lined roads, the conventional kickstand may hooked by the branches or twigs of the trees so that the rider might fall from the bicycle. As a result, to install the kickstand on the bicycle is not recommended.

The present invention has arisen to mitigate and/or obviate the disadvantages of the conventional.

### SUMMARY OF THE INVENTION

The main objective of the present invention is to provide a parking device.

To achieve the objective, a parking device for a bicycle comprises an inflator and a connecting member, the inflator having a nozzle defined thereon, the connecting member having an inserting part at one end thereof and an assembling part at another end thereof, the inserting part of the connecting member inserted into the nozzle, the assembling part assembled on the bicycle. Wherein, the inserting part is cylindrical; the inflator has an inner cylinder and an outer cylinder; the outer cylinder is axially moved relative to the inner cylinder to elongate or to shorten a length of the inflator; the outer cylinder is axially assembled to one end of the inner cylinder; the nozzle is assembled to another end of the inner cylinder; the assembling part has an assembling hole opened at one end thereof; the assembling hole is opposite to the inserting part; the assembling hole of the connecting member is passed through by the terminal part of the wheel axle of the bicycle; a locking assembly is assembled on one end of the outer cylinder which is assembled to the inner cylinder; the locking assembly locks or unlocks the movement of the outer cylinder relative to the inner cylinder; the assembling part has an engaging groove opened thereon; the engaging groove of the assembling part is buckledly connected to the crank arm of the bicycle.

Under this arrangement, a user connects the inflator to the bicycle via the connecting member to park the bicycle stably; in contrast, when the user wants to ride the bicycle, the connecting member and the inflator are able to be assembled on the bicycle.

Further benefits and advantages of the present invention will become apparent after a careful reading of the detailed description with appropriate reference to the accompanying drawings.

### BRIEF DESCRIPTION OF THE DRAWINGS

FIG. 1 is an exploded view of a first embodiment of a parking device for a bicycle of the present invention;

FIG. 2 is a perspective view of the first embodiment of the parking device for a bicycle;

FIG. 3 is a perspective view for showing the first embodiment of the parking device for a bicycle is assembled on frames of the bicycle;

FIG. 4 is a perspective view for showing the first embodiment of the parking device for a bicycle is connectable to the wheel axle of the bicycle via the connecting member;

FIG. 5 is a perspective view for showing the first embodiment of the parking device for a bicycle is connected to the wheel axle of the bicycle via the connecting member;

FIG. 6 is a perspective view for showing a second embodiment of the parking device for a bicycle is connectable to the crank axle of the bicycle via the connecting member;

FIG. 7 is a perspective view for showing the second embodiment of the parking device for a bicycle is connected to the crank axle of the bicycle via the connecting member;

FIG. 8 is an exploded view of a third embodiment of a parking device for a bicycle;

FIG. 9 is a perspective view for showing the third embodiment of the parking device for a bicycle is connectable to the wheel axle of the bicycle via the connecting member;

FIG. 10 is an exploded view of a fourth embodiment of a parking device for a bicycle; and

FIG. 11 is a perspective view for showing the fourth embodiment of the parking device for a bicycle is connectable to the crank arm of the bicycle via the connecting member.

### DETAILED DESCRIPTION OF THE INVENTION

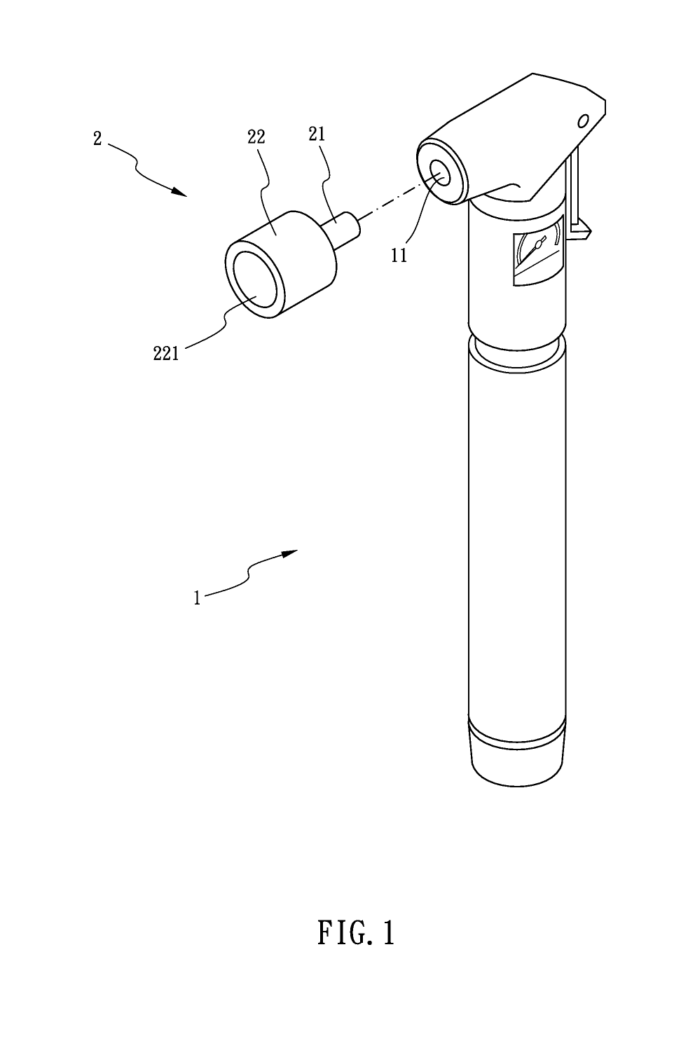

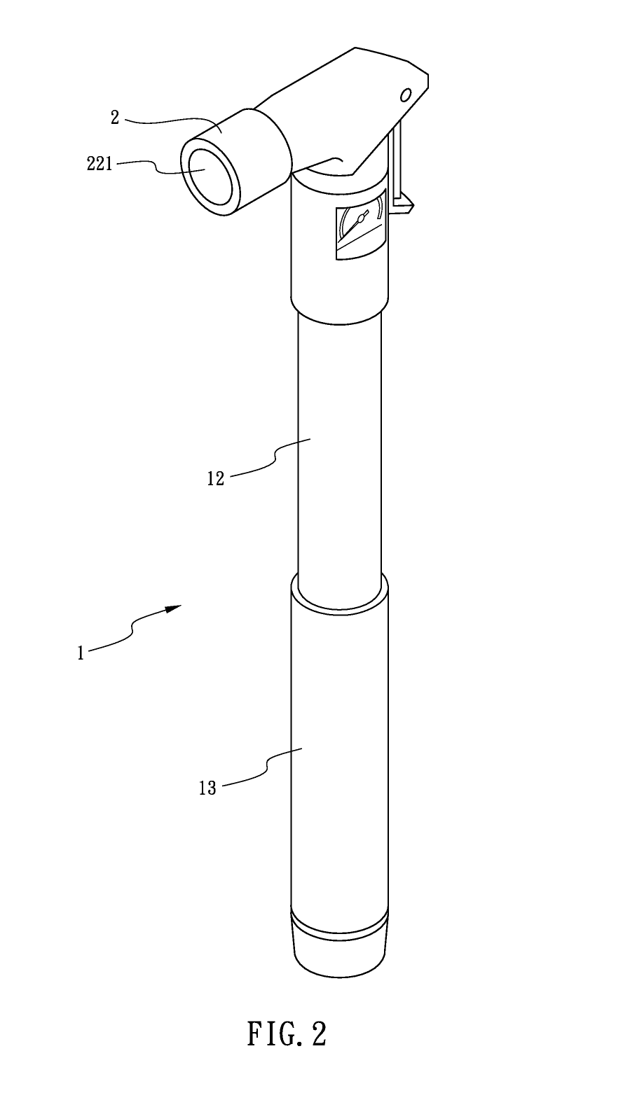

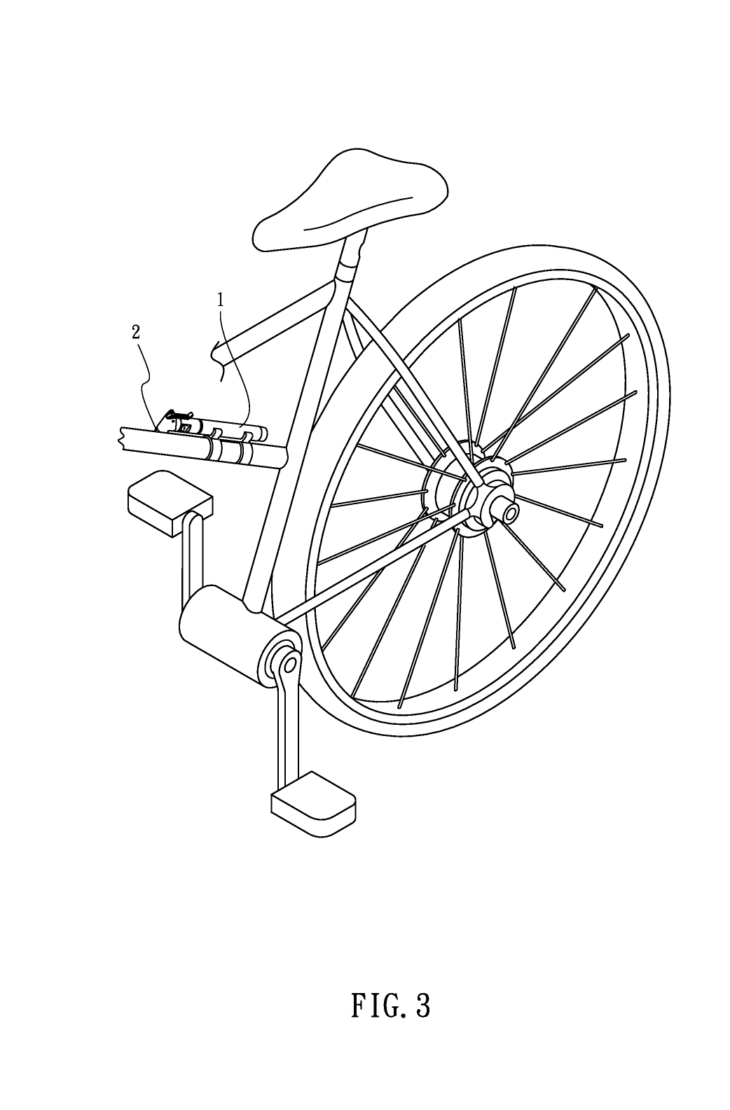

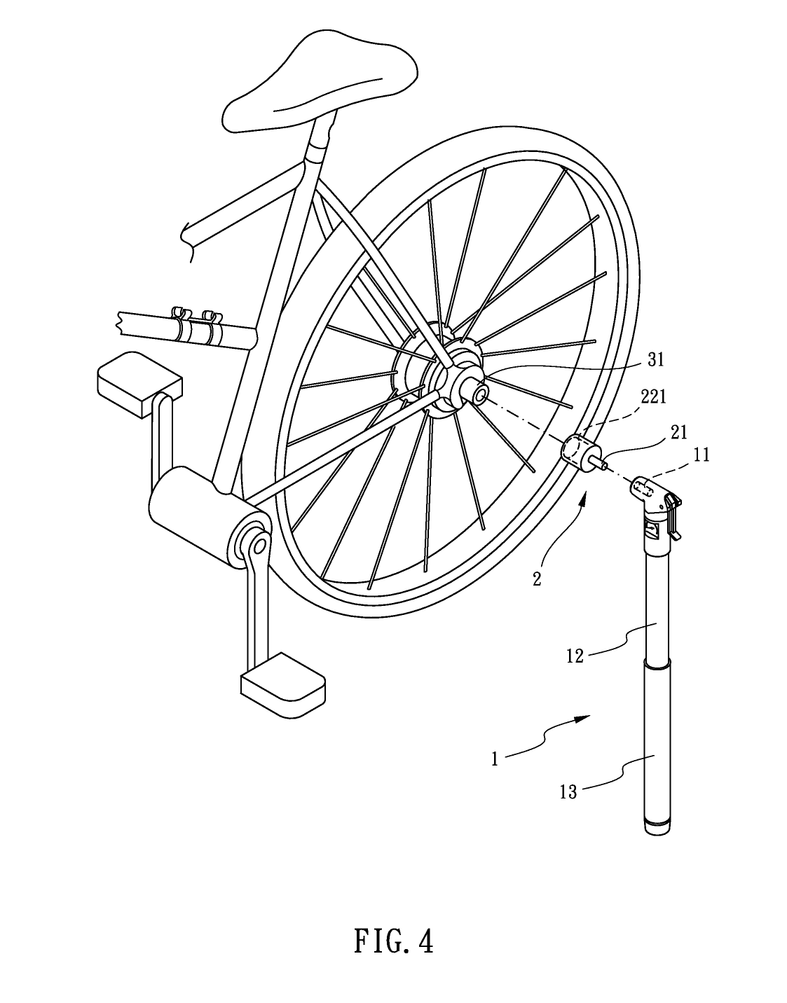

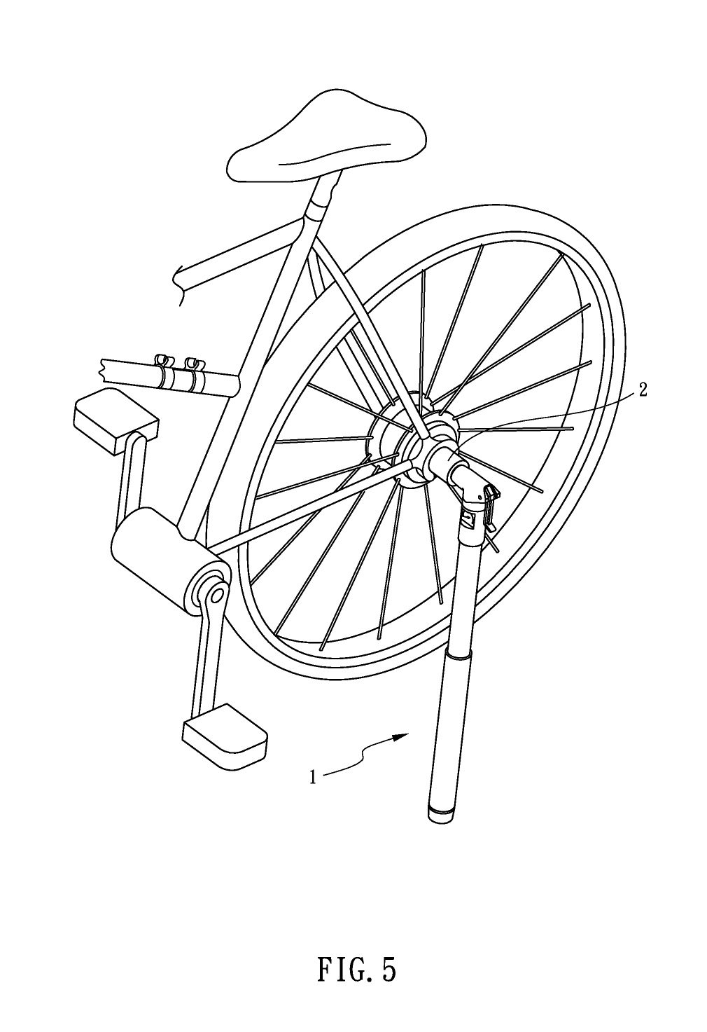

Referring to FIGS. 1-5, a parking device for a bicycle in accordance with the present invention comprises an inflator 1 and a connecting member 2.

The inflator has a nozzle 11 defined thereon.

The connecting member 2 has an inserting part 21 at one end thereof and an assembling part 22 at another end thereof. The inserting part 21 of the connecting member 2 is inserted into the nozzle 11. The assembling part 22 is assembled on a terminal part of a wheel axle 31.

Under this arrangement, a user connects the inflator 1 to the bicycle via the connecting member 2 to park the bicycle stably. When the user wants to ride the bicycle, the connecting member 2 and the inflator 1 can be assembled on the frames of the bicycle.

The detailed operations of the present invention are described as following.

The assembling part 22 has an assembling hole 221 opened at one end thereof. The assembling hole 221 is opposite to the inserting part 21. The inserting part 21 is cylindrical. The inflator 1 has an inner cylinder 12 and an outer cylinder 13. The outer cylinder 13 is axially moved relative to the inner cylinder 12 to elongate or to shorten a length of the inflator 1. The outer cylinder 13 is axially assembled to one end of the inner cylinder 12. The nozzle 11 is assembled to another end of the inner cylinder 12.

When the user wants to park the bicycle, the user take off the inflator 1 from the bicycle; then the inserting part 21 of the connecting member 2 is inserted into the nozzle 11 of the inflator 1; thereby the assembling hole 221 of the connecting member 2 is passed through by the terminal part of the wheel axle 31 of the bicycle (In this embodiment, the wheel axle 31 is a rear wheel axle.). Under this arrangement, the user moves the outer cylinder 13 relative to the inner cylinder 12 to appropriately elongate the length of the inflator 1 so as to park the bicycle stably. Conversely, when the user wants to ride the bicycle, the connecting member 2 and the inflator 1 are removed from the terminal part of the wheel axle 31 and are reassembled on the frames of the bicycle.

Under this arrangement, the bicycle can be parked stably via the combination of the inflator 1 and the connecting member 2 which are installed on the bicycle when the user is riding the bicycle. Therefore, the user does not have to lean the bicycle on a wall of a building or a fence. In addition, the user does not have to install an extra kickstand which might increase the weight of the bicycle.

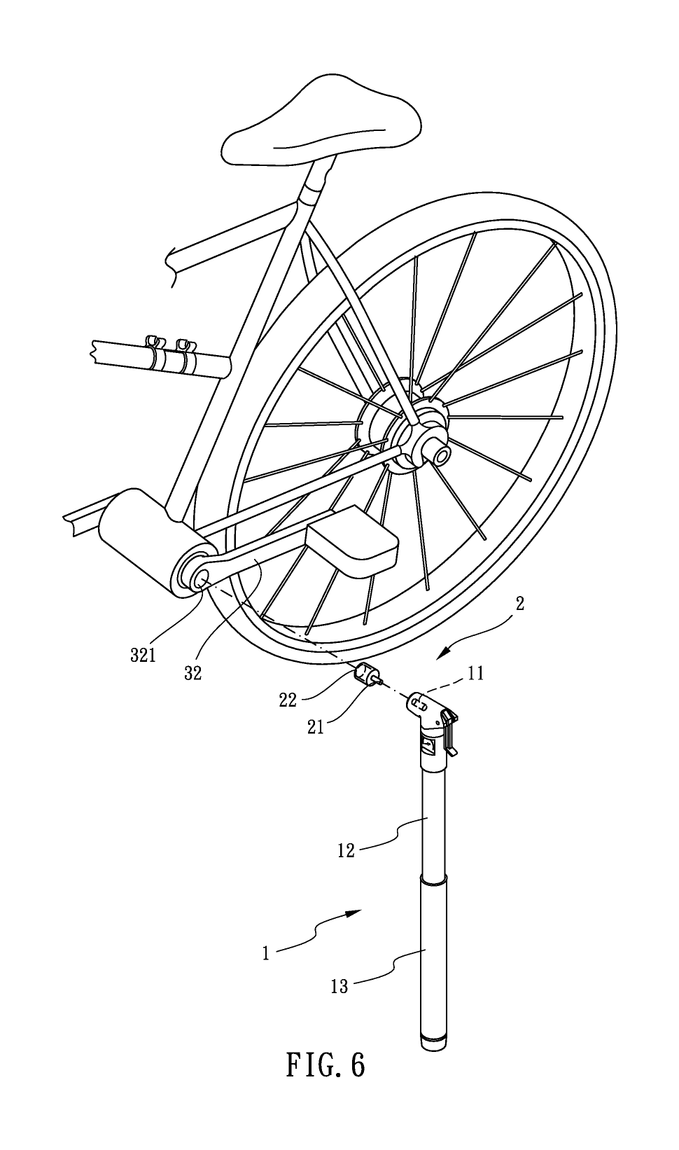

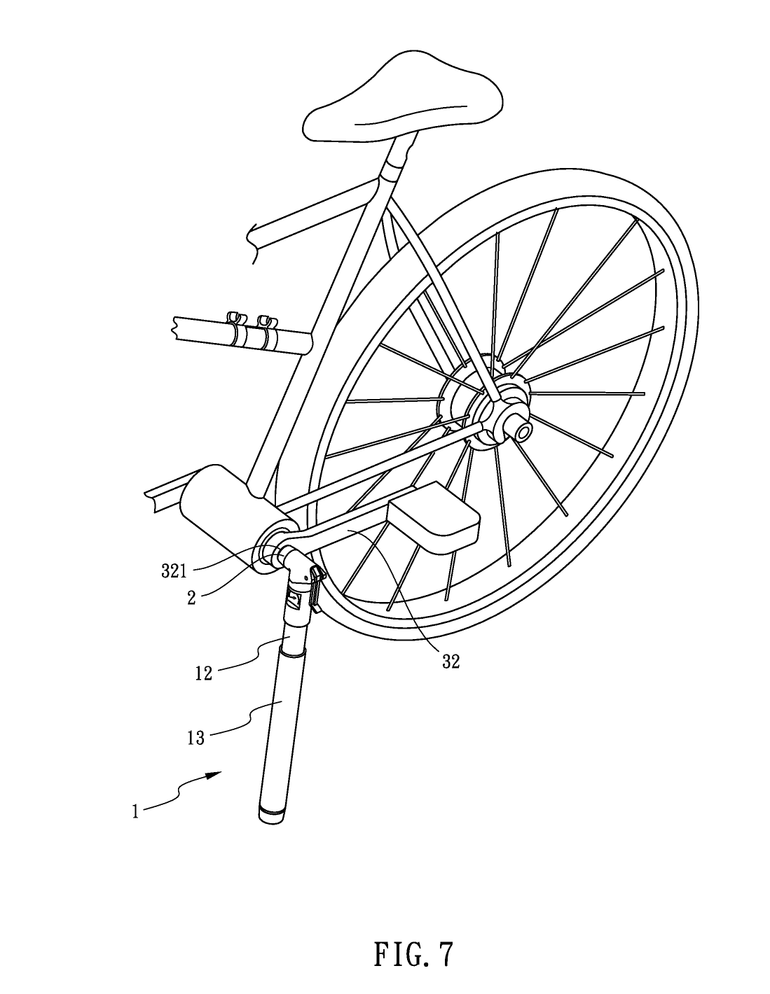

Referring to FIG. 6 and FIG. 7, a second embodiment of the present invention is intended to use on a crank axle 32 of the bicycle. The second embodiment of the present invention comprises an inflator 1 and a connecting member 2.

The inflator has a nozzle 11 defined thereon. The inflator 1 has an inner cylinder 12 and an outer cylinder 13. The outer cylinder 13 is axially moved relative to the inner cylinder 12 to elongate or to shorten the length of the inflator 1. The outer cylinder 13 is axially assembled to one end of the inner cylinder 12. The nozzle 11 is assembled to another end of the inner cylinder 12.

The connecting member 2 has an inserting part 21 at one end thereof and an assembling part 22 at another end thereof. The inserting part 21 of the connecting member 2 is inserted into the nozzle 11. The assembling part 22 is assembled into the crank hole 321 of the crank axle 32 of the bicycle. The inserting part 21 is cylindrical.

Under this arrangement, the inflator 1 is assembled into the crank hole 321 of the crank axle 32 of the bicycle via the connecting member 2, and the outer cylinder 13 is axially moved relative to the inner cylinder 12 so that the total length of the inflator 1 is shortened for parking, and the terminal of the inflator 1 is stand on the grounds. In the second embodiment, the inflator 1 is assembled on the crank axle 32 which is closer to the middle part of the bicycle longitudinally, namely, a position between a front wheel and a rear wheel of the bicycle, therefore, the inflator 1, the front wheel and the rear wheel contact with the ground and form a triangle to provide the user a better way to park the bicycle more stably.

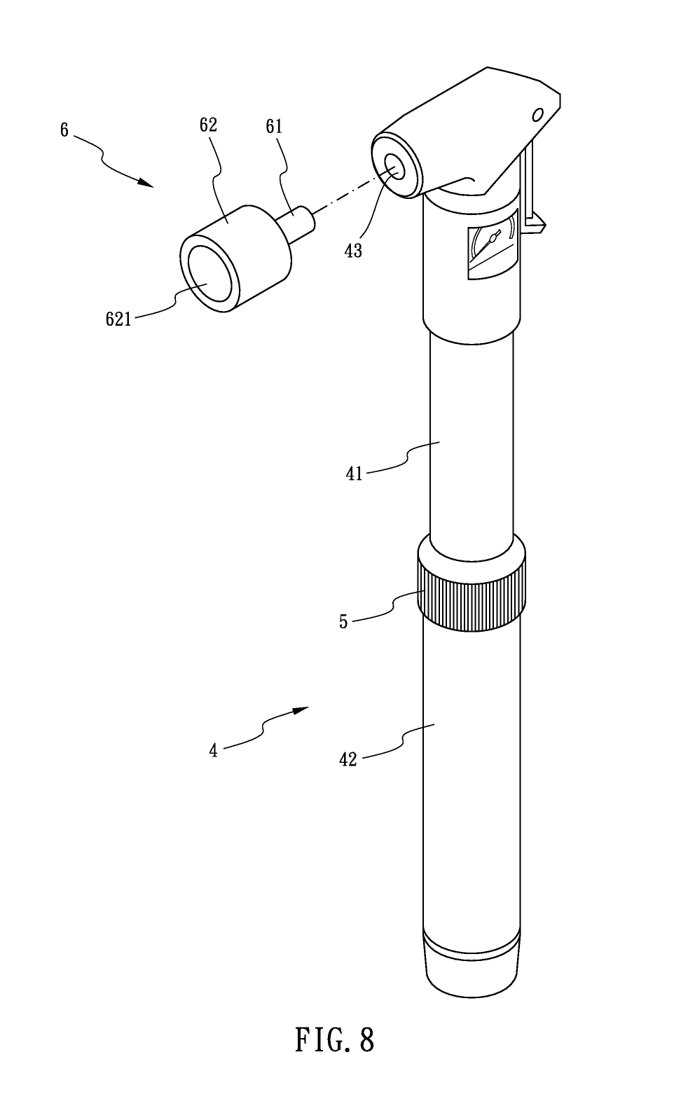

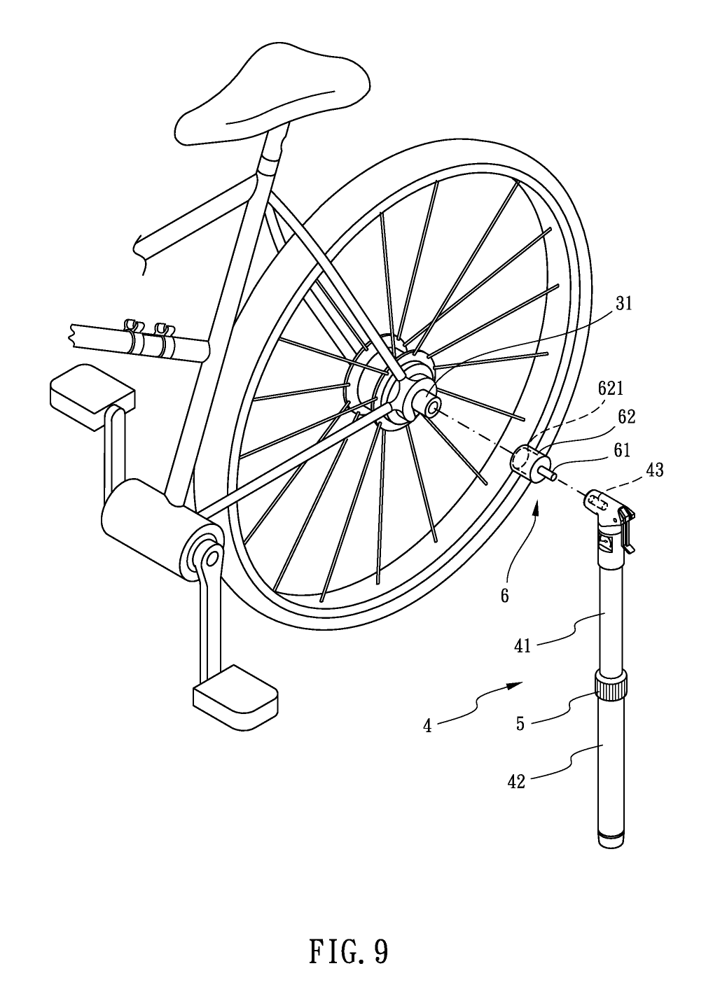

Referring to FIG. 8 and FIG. 9, a third embodiment of the present invention comprises an inflator 4, a locking assembly 5 and a connecting member 6.

The inflator 4 has an inner cylinder 41 and an outer cylinder 42. The outer cylinder 42 is axially assembled to one end of the inner cylinder 41. The outer cylinder 42 is axially moved relative to the inner cylinder 41 to elongate or to shorten the length of the inflator 4. A nozzle 43 is assembled to another end of the inner cylinder 41.

The locking assembly 5 is assembled on one end of the outer cylinder 42 which is assembled to the inner cylinder 41. The locking assembly 5 locks or unlocks the movement of the outer cylinder 42 relative to the inner cylinder 41.

The connecting member 6 has an inserting part 61 at one end thereof and an assembling part 62 at another end thereof. The inserting part 61 of the connecting member 6 is inserted into the nozzle 43. The assembling part 62 is assembled on the terminal part of a wheel axle 31. The assembling part 62 has an assembling hole 621 opened at one end thereof. The assembling hole 621 of the connecting member 6 is passed through and combined firmly with the terminal part of the wheel axle 31 of the bicycle. The inserting part 61 is cylindrical.

Under this arrangement, the user connects the inflator 4 with the bicycle via the connecting member 6; then the locking assembly 5 locks or unlocks the movement of the outer cylinder 42 relative to the inner cylinder 41 so as to adjust an appropriate length for the inflator 4 to stably park the bicycle. When the user is riding the bicycle, the inflator 4 and the connecting member 6 can be installed on the bicycle.

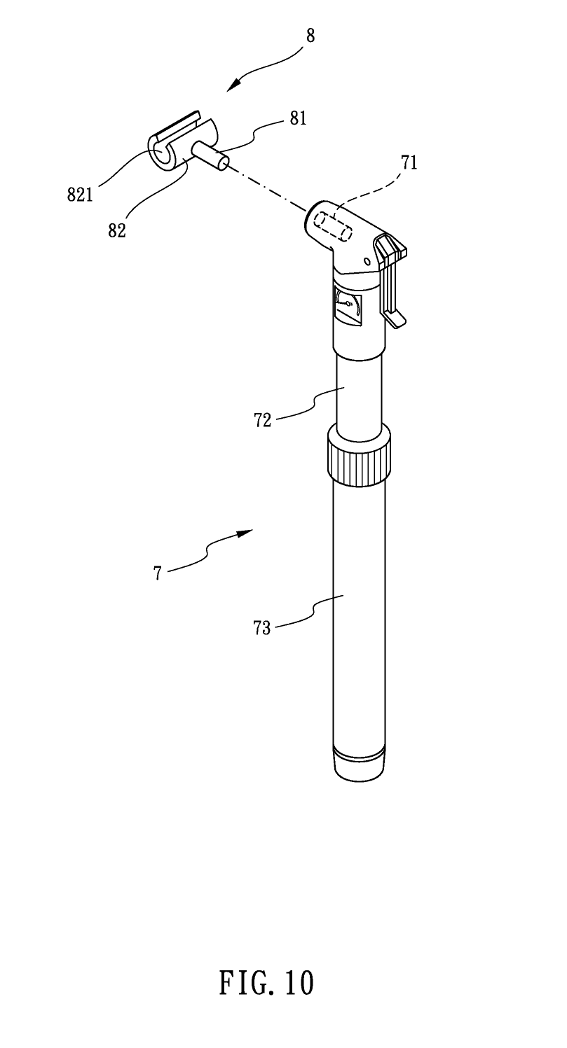

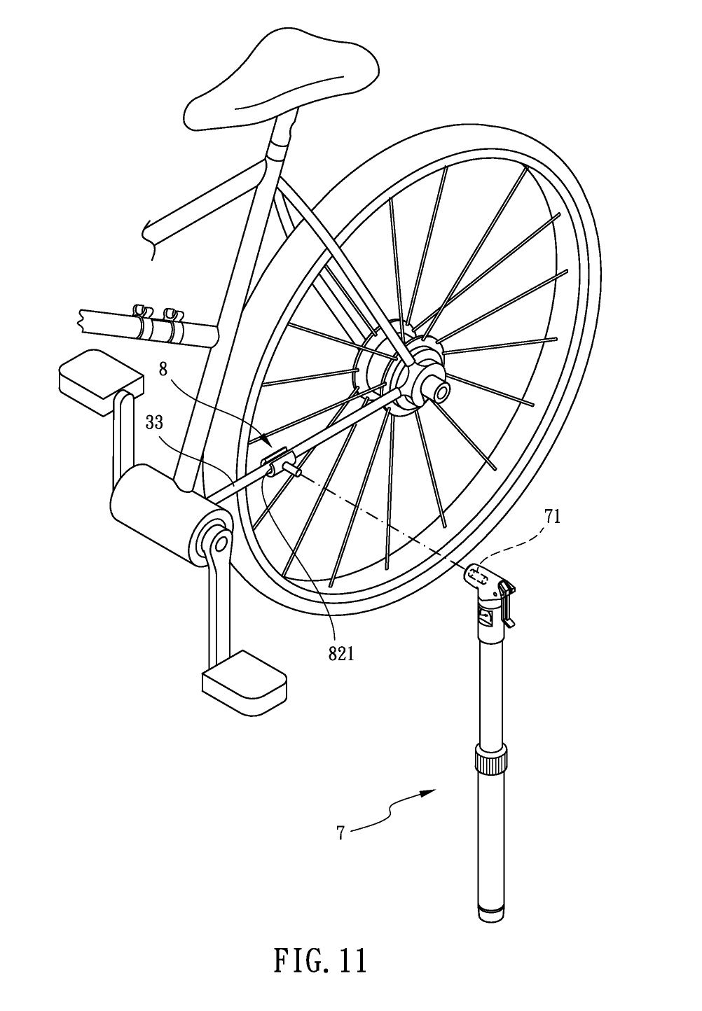

Referring to FIG. 10 and FIG. 11, a fourth embodiment of the present invention comprises an inflator 7 and a connecting member 8.

The inflator 7 has a nozzle 71 defined thereon. The inflator 7 has an inner cylinder 72 and an outer cylinder 73. The outer cylinder 73 is axially moved relative to the inner cylinder 72 to elongate or to shorten the length of the inflator 7. The outer cylinder 73 is axially assembled to one end of the inner cylinder 72. The nozzle 71 is assembled to another end of the inner cylinder 72.

The connecting member 8 has an inserting part 81 at one end thereof and an assembling part 82 at another end thereof. The inserting part 81 of the connecting member 8 is inserted into the nozzle 71. The assembling part 82 has an engaging groove 821 opened thereon, and the engaging groove 821 of the assembling part 82 is buckledly connected to a crank arm 33 of the bicycle (in this embodiment, the engaging groove buckledly connected to a chain stay of the bicycle.).

Under this arrangement, the user connects the inflator 7 with the bicycle via the connecting member 8 so as to stably park the bicycle. When the user is riding the bicycle, the inflator 7 and the connecting member 8 can be installed on the bicycle.

Although the invention has been explained in relation to its preferred embodiment, it is to be understood that many other possible modifications and variations can be made without departing from the spirit and scope of the invention as hereinafter claimed.

1. A bicycle parking device with inflating function comprising an inflator and a connecting member;
the inflator having a nozzle defined thereon; and
the connecting member having an inserting part at one end thereof and an assembling part at another end thereof, the inserting part of the connecting member inserted into the nozzle, the assembling part assembled into a crank hole of a crank axle of the bicycle;
wherein a user connects the inflator to the bicycle via the connecting member to park the bicycle stably, and a terminal of the inflator, a front wheel and a rear wheel of the bicycle all contact with the ground to park the bicycle more stably; in contrast, when the user wants to ride the bicycle, the connecting member and the inflator are able to be assembled on the bicycle.

2. The bicycle parking device with inflating function as claimed in claim 1, wherein the inserting part is cylindrical; the inflator has an inner cylinder and an outer cylinder; the outer cylinder is axially moved relative to the inner cylinder to elongate or to shorten a length of the inflator; the outer cylinder is axially assembled to one end of the inner cylinder; the nozzle is assembled to another end of the inner cylinder.

3. A bicycle parking device with inflating function comprising an inflator and a connecting member;
the inflator 4-having a nozzle defined thereon; and
the connecting member having an inserting part at one end thereof and an assembling part at another end thereof, the inserting part of the connecting member inserted into the nozzle, the assembling part assembled on a terminal part of a wheel axle;
wherein a user connects the inflator to the bicycle via the connecting member to park the bicycle stably, and a terminal of the inflator, a front wheel and a rear wheel of the bicycle all contact with the ground to park the bicycle more stably; in contrast, when the user wants to ride the bicycle, the connecting member and the inflator are able to be assembled on the bicycle.

4. The bicycle parking device with inflating function as claimed in claim 3, wherein the assembling part has an assembling hole opened at one end thereof; the assembling hole is opposite to the inserting part; the assembling hole of the connecting member is passed through by the terminal part of the wheel axle of the bicycle; the inserting part is cylindrical.

5. The bicycle parking device with inflating function as claimed in claim 3, wherein the inflator has an inner cylinder and an outer cylinder; the outer cylinder is axially moved relative to the inner cylinder to elongate or to shorten a length of the inflator; the outer cylinder is axially assembled to one end of the inner cylinder; the nozzle is assembled to another end of the inner cylinder.

6. The bicycle parking device with inflating function as claimed in claim 3, wherein a locking assembly is assembled on one end of the outer cylinder which is assembled to the inner cylinder; the locking assembly locks or unlocks the movement of the outer cylinder relative to the inner cylinder.

7. A bicycle parking device with inflating function comprising an inflator and a connecting member;
the inflator having a nozzle defined thereon; and
the connecting member having an inserting part at one end thereof and an assembling part at another end thereof, the inserting part of the connecting member inserted into the nozzle, the assembling part is buckledly connected to a crank arm of the bicycle;
wherein a user connects the inflator to the bicycle via the connecting member to park the bicycle stably, and a terminal of the inflator, a front wheel and a rear wheel of the bicycle all contact with the ground to park the bicycle more stably; in contrast, when the user wants to ride the bicycle, the connecting member and the inflator are able to be assembled on the bicycle.

8. The bicycle parking device with inflating function as claimed in claim 7, wherein the assembling part has an engaging groove opened thereon; the engaging groove of the assembling part is buckledly connected to the crank arm of the bicycle.

9. The bicycle parking device with inflating function as claimed in claim 7, wherein the inflator has an inner cylinder and an outer cylinder; the outer cylinder is axially moved relative to the inner cylinder to elongate or to shorten a length of the inflator; the outer cylinder is axially assembled to one end of the inner cylinder; the nozzle is assembled to another end of the inner cylinder.
